(19) United States
(12) Patent Application Publication
(10) Pub. No.: US 2009/0265510 A1
(43) Pub. Date: Oct. 22, 2009

(54) Systems and Methods for Distributing Hot Spare Disks In Storage Arrays

(75) Inventors: Clayton H. Walther, Austin, TX (US); Vadim Vsevolodovich Ivanov, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 12/105,049

(22) Filed: Apr. 17, 2008

(51) Int. Cl. G06F 12/00

(52) U.S. Cl. 711/114; 711/E12.001

(57) ABSTRACT

In one embodiment, a system may include a storage array and a controller. The storage array may include a plurality of storage resources, where each storage resource of the plurality of storage resources may include plurality of active storage drives and a plurality of hot spare drives. The controller, coupled to the storage array, may be configured to generate a mapping of the location of hot spare drives in the plurality of storage resources; detect a failure in an active storage drive in a first storage resource of the plurality of storage resources; using at least the map, select a hot spare drive in a second storage resource for rebuilding the active storage drive in the first storage resource; and provide the selected hot spare drive in the second storage resource to rebuild the failed active storage drive in the first storage resource.

### TECHNICAL FIELD

The present disclosure relates in general to storage devices, and more particularly to distributing hot spare disks in storage arrays.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use an array of storage resources, such as a Redundant Array of Independent Disks (RAID), for example, for storing information. Arrays of storage resources typically utilize multiple disks to perform input and output operations and can be structured to provide redundancy which may increase fault tolerance. Other advantages of arrays of storage resources may be increased data integrity, throughput, and/or capacity. In operation, one or more storage resources disposed in an array of storage resources may appear to an operating system as a single logical storage unit or “virtual resource.”

In a typical configuration, a RAID may include active storage resources making up one or more virtual resources and a number of active spare storage resources (also known as “hot spares”). Using conventional approaches, when an active storage resource fails, the data in the active storage resource may be rebuilt using an active spare. However, if an active spare is unavailable, the failed active storage disk will have often cannot be recovered and may suffer data loss.

### SUMMARY

In accordance with the teachings of the present disclosure, disadvantages and problems associated with diagnosis and allocation of storage resources may be substantially reduced or eliminated.

In one embodiment, a system may include a storage array and a controller. The storage array may include a plurality of storage resources, where each storage resource of the plurality of storage resources may include plurality of active storage drives and a plurality of hot spare drives. The controller, coupled to the storage array, may be configured to generate a mapping of the location of hot spare drives in the plurality of storage resources; detect a failure in an active storage drive in a first storage resource of the plurality of storage resources; using at least the map, select a hot spare drive in a second storage resource for rebuilding the active storage drive in the first storage resource; and provide the selected hot spare drive in the second storage resource to rebuild the failed active storage drive in the first storage resource.

In another embodiment, a system may include an information handling system, a storage array coupled to the information handling system via a network, where the storage array may include a plurality of storage resources including a plurality of active storage drives and a plurality of hot spare drives; and a controller coupled to the plurality of storage resources. The controller may be configured to generate a mapping of the location of hot spare drives in the plurality of storage resources; detect a failure in an active storage drive in a first storage resource of the plurality of storage resources; using at least the map, select a hot spare drive in a second storage resource for rebuilding the active storage drive in the first storage resource; and provide the selected hot spare drive in the second storage resource to rebuild the failed active storage drive in the first storage resource.

In another embodiment, a method includes, in an array of storage resources including a plurality of active storage drives and a plurality of hot spare drives, generating a mapping of a location of each of the hot spare drives within a plurality of storage resources; detecting a failure in an active storage drive in a first storage resource in the array of storage resources; using at least the map, selecting a hot spare drive in a second storage resource in the array of storage resources for rebuilding the active storage drive in the first storage resource; and providing the selected hot spare drive in the second storage resource to rebuild the failed active storage drive in the first storage resource.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example storage system including an array of storage resources and a controller, in accordance with an embodiment of the present disclosure; and

FIG. 2 illustrates a method for rebuilding a failed disk drive using a hot spare drive in an array of storage resources, in accordance with an embodiment of the present disclosure.

### DETAILED DESCRIPTION

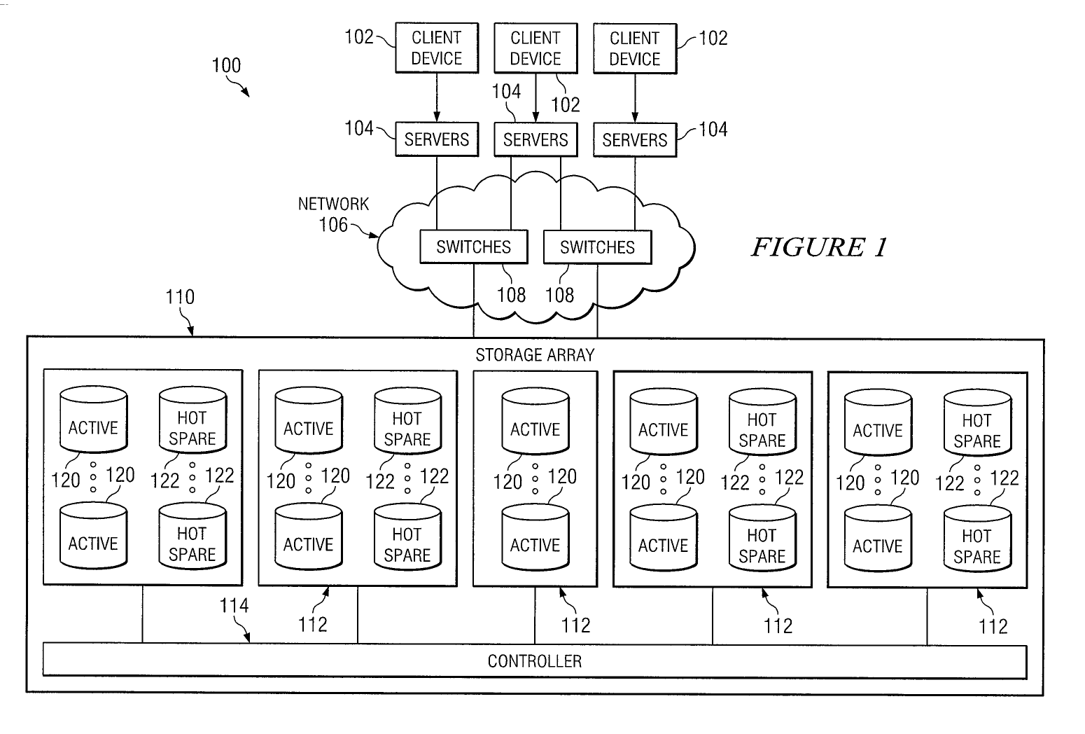

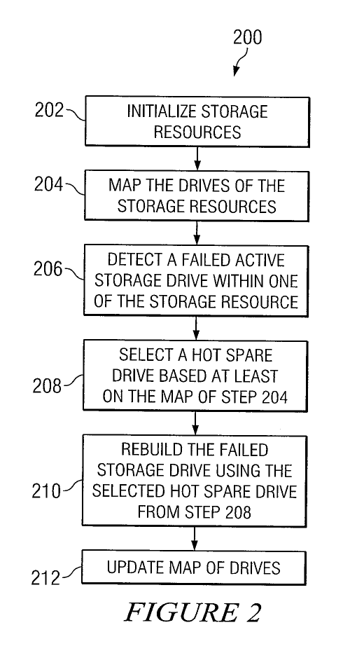

Preferred embodiments and their advantages are best understood by reference to FIGS. 1-2, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and/or a video display. The information handling system may also include one or more buses operable to transmit communications between the various hardware components.

As discussed above, an information handling system may include an array of storage resources. The array of storage resources may include a plurality of storage resources, and may be operable to perform one or more input and/or output storage operations, and/or may be structured to provide redundancy. In operation, one or more storage resources disposed in an array of storage resources may appear to an operating system as a single logical storage unit or “virtual resource.”

Often, storage resource arrays are used in connection with data backup. In general, “backup” refers to making copies of data that may be used to restore the original set of data after a data loss event. For example, data backup may be useful to restore an information handling system to an operational state following a catastrophic loss of data (sometimes referred to as “disaster recovery”). In addition, data backup may be used to restore individual files after they have been corrupted or accidentally deleted. In many cases, data backup requires significant storage resources. Organizing and maintaining a data backup system and its associated storage resources often requires significant management and configuration overhead.

In certain embodiments, an array of storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity checking. As known in the art, RAIDs may be implemented according to numerous RAID standards, including without limitation, RAID 0, RAID 1, RAID 0+1, RAID 3, RAID 4, RAID 5, RAID 6, RAID 01, RAID 03, RAID 10, RAID 30, RAID 50, RAID 51, RAID 53, RAID 60, RAID 100, and/or others.

FIG. 1 illustrates a block diagram of an example system 100 for restoring failed data storage drive(s), in accordance with the teachings of the present disclosure. As depicted, system 100 may include one or more host client devices 102, one or more servers 104, a network 106 comprising one or more switches 108, and a storage array 110 comprising one or more storage resources 112. Client devices 102 and/or servers 104 may comprise information handling systems (IHS) where each IHS may generally be operable to read data from and/or write data to one or more storage resources 112 disposed in storage array 110. In the same or alternative embodiments, other information handling systems not shown may be used to access storage resources 112 via network 106.

Network 106 may be a network and/or fabric configured to couple client devices 102 and/or servers 104 to storage resources 112 disposed in storage array 110 via switches 108. In certain embodiments, network 106 may allow client devices 102 and/or servers 104 to connect to storage resources 112 disposed in storage array 110 such that the storage resources 112 appear to client devices 102 and/or servers 104 as locally attached storage resources. In the same or alternative embodiments, network 106 may include a communication infrastructure, which provides physical connections, and a management layer, which organizes the physical connections, storage resources 112 of storage array 110, and client devices 102 and/or servers 104.

Network 106 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet, or any other appropriate architecture or system that facilitates the communication of signals, data, and/or messages (generally referred to as data). Network 106 may transmit data using any storage and/or communication protocol, including without limitation, Fibre Channel, Frame Relay, Asynchronous Transfer Mode (ATM), Internet protocol (IP), other packet-based protocol, small computer system interface (SCSI), advanced technology attachment (ATA), serial ATA (SATA), advanced technology attachment packet interface (ATAPI), serial storage architecture (SSA), integrated drive electronics (IDE), and/or any combination thereof. Network 106 and its various components such as switches 108 may be implemented using hardware, software, or any combination thereof.

Storage array 110 may include storage resources 112 and controller 114, and may be communicatively coupled to client devices 102 and/or servers 104 and/or network 106, in order to facilitate communication of data between client devices 102 and/or servers 104 and storage resources 112. In the same or alternative embodiment, one or more client devices 102 and/or servers 104 may be communicatively coupled to one or more storage array 110 without network 104 or other network. For example, in certain embodiments, one or more physical storage resources 112 may be directly coupled and/or locally attached to one or more client devices 102 and/or servers 104.

Storage resources 112 may include one or more hard disk drives, magnetic tape libraries, optical disk drives, magneto-optical disk drives, compact disk drives, compact disk arrays, disk array controllers, and/or any other system, apparatus or device operable to store data. Storage resources 112 may each include one or more active storage drives 120 and/or one or more active spare storage drives 122 (also known as “hot spares” or “hot spare drives”). In some embodiments, each storage resource 112 may be embodied as a physical storage enclosure, wherein each storage resource 112 may comprise one or more active storage drives 120 and/or one or more hot spare drives 122. In the same or alternative embodiments, a storage resource 112 may contain only active storage drives 120 or only hot spare drives 122.

The plurality of storage resources 112 within storage array 110 may provide one or more hot spare drives 122 to replace a failed active storage drive 120 when an active storage drive failure occurs. In one embodiment, when one or more active storage drives 120 in a first storage resource 112 fails, hot spare drives 122 from the first storage resource 112 and/or hot spare drives 122 from the other storage resources 112 of storage array 110 may be used to replace the failed active storage drive(s) 120. The use of hot spare drives 122 from a storage resource 112 other than the storage resource 112 in which the failure occurs may reduce and/or eliminate data loss when a failure occurs, e.g., in situations in which the storage resource 112 in which the failure occurs does not include a sufficient number of hot spare drives 122 to rebuild the failed active storage drive 120.

Controller 114 may include any system, apparatus, or device configured to detect the number of storage resources 112 within storage array 110 and allocate a hot spare drive 122 of any one of the storage resource 112 when a failure of an active storage drive 120 occurs. Controller 114 may include software, firmware, or other logic embodied in a tangible computer readable media for providing such functionality. As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or a physical or virtual storage resource.

In operation, during the boot up of system 100, controller 114 may determine the number of storage resources 112 within storage array 110. Controller 114 may determine the number of hot spare disks 122 in each of the storage resources 112, and whether the hot spare drives 122 of each storage resource 112 are available in case of failure of an active storage drive 120 in any storage resource(s) 112 of storage array 110. Controller 114 may map the hot spare drives 122 of each storage resource 112 that are available (e.g., unused and/or available) for rebuilding a failed active storage drive 120 in any of storage resources 112.

In some embodiments, controller 114 may test the speed of the active storage drive(s) 120 and/or the hot spare drive(s) 122 in each of storage resource 112 and may determine parameters including, for example, I/O speed, connection speed, throughput value, and other parameters. In some embodiments, controller 114 may also build a map (e.g., a table, a database, or other similar data structure) to store such parameters. When an active storage drive 120 of storage resource 112 fails, controller 114 may use the map to determine one or more particular hot spare drives 122 expected to allow for the fastest rebuild of the failed active storage drive 120 based on at least (a) the proximity of the available hot spare drives 122 to the storage resource(s) 112 in which the failure occurred and/or (b) the speed of the available hot spare drives 122.

For example, controller 114 may identify one or more hot spare drives 122 that are proximal or “close” to the storage resource 112 including the failed active storage drive 120. For example, using the map, controller 114 may determine if a hot spare(s) 122 local to the storage resource 112 that includes the failed active storage drive 120 are available. If a local hot spare drive 122 is not available, controller 114 may determine if a hot spare drive 122 is available in other storage resources 112 within storage array 110. In one example, controller 114 may determine the fastest available hot spare drive 122, whether local to storage resource 112 that includes the failed active storage drive 120, or from another storage resource 112 in storage array 110. In addition, in some embodiments, controller 114 may consider both the proximity and the speed of available hot spare drives 122 in making the determination. By choosing a hot spare 122 that is fast relative to other available hot spares 122 and/or proximal to the storage resource 112 including the failed active storage drive 120, the rebuild time of the failed active storage drive 120 may be reduced.

Controller 114 may also dynamically update any changes that occur in any storage resource 112 in substantially real-time. In some embodiments, controller 114 may send a signal to each storage resource 112 (e.g., ping storage resource 112) to request an update. Any changes to storage resource 112 including the number of hot spare drives 122 available may be dynamically recorded in the map generated by controller 114 as discussed above.

FIG. 2 illustrates a method 200 for rebuilding a failed storage drive using a hot spare drive 122 in an array of storage resources 112, in accordance with embodiments of the present disclosure. At step 202, controller 114 may initialize the storage resources 112 in storage array 110. The initialization may be done during the boot up of system 100 or at another suitable time. In some embodiments, controller 114 may determine various parameters for each storage resource 112 in storage array 110. For example, controller 114 may determine the number of storage resources 112 in storage array 110, the load of each storage resource 112, the connection speed of each storage resource 112 (e.g., speed of the connection path between one storage resource to another storage resource), the throughput of each storage resource 112 (e.g., I/O speed), and/or the number of active storage drives 120 and/or hot spare drives 122 in each storage resource 112.

At step 204, controller 114 may map the various parameters determined at step 202 (e.g., in a list, table, database, etc.) to unique identifiers for the storage resources 112 and/or individual drives thereof (e.g., an IP address of each storage resource 112 and/or drive). From this map, controller 114 may be able to determine the location of each hot spare drive 122 relative to the active storage drives 120 within a storage resource 112 and/or relative to the active storage drives 120 of other storage resources 112 within storage array 110, as described below. Controller 114 may also access parameters collected during past initializations that may provide historical data of each storage resource 112, and may record such information in the map.

At step 206, controller 114 may detect a disk failure of an active storage drive 120 in a storage resource 112 in storage array 110. In addition or alternatively, client device 102 and/or server 104 may detect a disk failure of an active storage drive 120 in storage resource 112 and may send a signal via network 106 to controller 114 alerting of the failure.

At step 208, controller 114 may select a hot spare drive 122 to use for the rebuilding process. In some embodiments, if a local hot spare drive 122 (e.g., within the storage resource 112 containing the failed active storage drive 120) is available, controller 114 may provide the available local hot spare drive 122 to rebuild the failed active storage drive 120.

If no local hot spare drives 122 are available locally in the storage resource 112 that contained the failed active storage drive 120, controller 114 may use the map from step 204 to determine the nearest and/or fastest hot spare drive 122 available. For example, controller 114 may scan the map and select the least loaded source resource 112 (e.g., storage resource(s) that are idle, have no pending input and/or output request from client device 102 and/or server 104, etc.) with at least one hot spare drive 122 that has a relatively fast communication path. The determination for the least loaded source resource 112 may be from, for example, the initialization in step 202 and/or from historical data of the source resource 112 that is populated by controller 114. In another example, controller 114 may scan the map generated at step 204 and determine the fastest hot spare drive 122 in any storage resource 112 in storage array 110. By using a hot spare drive 122 proximal to the storage resource 112 with the failed active storage drive 120 and/or a fast hot spare drive 122, the time required to rebuild the failed active storage drive 120 may be reduced.

At step 210, controller 114 may provide the hot spare disk 122 selected in step 208 for rebuilding the failed active storage drive 120. In one embodiment, controller 114 may establish an iSCSI session with or couple via another transmission protocol to the storage resource 112 including the selected hot spare drive 122. Controller 114 may attach the selected hot spare drive 122 to the storage resource 112 including the failed active storage drive 120 and begin the drive rebuild process. After the rebuild process, the storage resource 112 including the rebuilt active storage drive 120 may be activated.

At step 212, controller 114 may update the map of drives to indicate that the selected hot spare drive 122 selected at step 208 may no longer be available as a hot spare drive 122. Step 212 may be performed automatically after the selection of the hot spare drive 122 at step 208. In the same or alternative embodiments, step 212 may be performed at a predetermined time set by controller 114, client device 102, and/or server 106. For example, after a predetermined time has elapsed, controller 114 may ping one, some, or all storage resources 112 within storage array 110 requesting updates of the active and/or hot spare drives 122 within each storage resource 112.

According to embodiments of the present disclosure, a pool of hot spare drives 122 accessible via a network may be used to rebuild a failed active storage drive when the hot spare drive(s) local to the failed active storage drive are unavailable. The pool of hot spare drives may utilize hot spare drives available in other storage resources to reduce and or eliminate the risk of data loss during the occurrence of a drive failure.

Although the present disclosure has been described in detail, it should be understood that various changes, substitutions, and alterations can be made hereto without departing from the spirit and the scope of the invention as defined by the appended claims.

What is claimed is:

1. A system, comprising:
a storage array including a plurality of storage resources including a plurality of active storage drives and a plurality of hot spare drives; and
a controller coupled to the storage array, the controller configured to:
generate a mapping of the location of hot spare drives in the plurality of storage resources;
detect a failure in an active storage drive in a first storage resource of the plurality of storage resources;
using at least the map, select a hot spare drive in a second storage resource for rebuilding the active storage drive in the first storage resource; and
provide the selected hot spare drive in the second storage resource to rebuild the failed active storage drive in the first storage resource.

2. The system of claim 1, wherein the first storage resource includes a hot spare drive that is not selected for rebuilding the failed active storage drive in the first storage resource.

3. The system of claim 1, wherein one or more of the plurality of storage resources comprise one or more active storage drives and one or more hot spare drives.

4. The system of claim 1, wherein mapping the hot spare drives in the plurality of storage resources comprises indicating a speed of each hot spare drive.

5. The system of claim 1, wherein the controller is further operable to update the mapping substantially in real-time.

6. The system of claim 5, wherein the controller is further operable to automatically update the mapping after providing the hot spare drive in the second storage resource to rebuild the failed active storage drive in the first storage resource.

7. The system of claim 5, wherein the controller is further operable to automatically update the map after a predetermined amount of time.

8. The system of claim 1, wherein mapping the location of each hot spare drives in the plurality of storage resources comprises indicating a physical location of each hot spare drive.

9. The system of claim 1, wherein the controller is configured to select the hot spare drive for rebuilding the failed active storage drive based at least on (a) a speed of each hot spare drive and (b) a physical location of each hot spare drive.

10. A method, comprising:
in an array of storage resources including a plurality of active storage drives and a plurality of hot spare drives, generating a mapping of a location of each of the hot spare drives within a plurality of storage resources;
detecting a failure in an active storage drive in a first storage resource in the array of storage resources;
using at least the map, selecting a hot spare drive in a second storage resource in the array of storage resources for rebuilding the active storage drive in the first storage resource; and
providing the selected hot spare drive in the second storage resource to rebuild the failed active storage drive in the first storage resource.

11. The method of claim 11, wherein mapping the location of each hot spare drive further comprises mapping the speed and the physical location of each hot spare drive.

12. The method of claim 11, further comprising updating the map substantially in real-time.

13. The method of claim 13, wherein updating the map comprises automatically updating the mapping after providing the hot spare drive in the second storage resource to rebuild the failed active storage drive in the first storage resource.

14. The method of claim 13, wherein updating the map comprises automatically updating the mapping after a predetermined amount of time.

15. An system, comprising:
an information handling system;
a storage array coupled to the information handling system via a network, the storage array comprising a plurality of storage resources including a plurality of active storage drives and a plurality of hot spare drives; and
a controller coupled to the plurality of storage resources, the controller configured to:
generate a mapping of the location of hot spare drives in the plurality of storage resources;
detect a failure in an active storage drive in a first storage resource of the plurality of storage resources;
using at least the map, select a hot spare drive in a second storage resource for rebuilding the active storage drive in the first storage resource; and
provide the selected hot spare drive in the second storage resource to rebuild the failed active storage drive in the first storage resource.

16. The system of claim 15, wherein the controller is further operable to map the speed of each hot spare drive.

17. The system of claim 15, wherein the controller is further operable to automatically update the mapping after providing the hot spare drive to rebuild the failed active storage drive.

18. The system of claim 15, wherein the controller is further operable to automatically update the mapping after a predetermined amount of time.

19. The system of claim 15, wherein mapping the hot spare drives in the plurality of storage resources comprises indicating a physical location of each hot spare drive.

20. The system of claim 15, wherein the controller is configured to select the hot spare drive for rebuilding the failed active storage drive based at least on (a) a speed of each hot spare drive and (b) a physical location of each hot spare drive.
